(19) United States
(12) Patent Application Publication
(10) Pub. No.: US 2023/0385855 A1
(43) Pub. Date: Nov. 30, 2023

(54) Industrial Trend Analysis System

(71) Applicant: Meshplus Co., Ltd., Taipei (TW)

(72) Inventors: Kuang-Jui Hu, Taipei (TW); Ying-Hsueh Tseng, Taipei (TW); Po-Hsun Wang, Taipei (TW)

(73) Assignee: Meshplus Co., Ltd., Taipei (TW)

(21) Appl. No.: 18/069,608

(22) Filed: Dec. 21, 2022

(30) Foreign Application Priority Data
May 26, 2022 (TW) 111119613

(51) Int. Cl. G06Q 30/0202; G06Q 30/0204

(52) U.S. Cl. CPC G06Q 30/0202; G06Q 30/0205

(57) ABSTRACT

The invention discloses an industrial trend analysis system comprising: a user data processing module and a group behavior analysis computing module. The user data processing module sorts website visiting cluster data and geographic location points visiting cluster data from a to-be-analyzed user cluster data. The group behavior analysis computing module is connected to the user data processing module to perform a market size analysis, a potential consumer group profile analysis, a consumer geographic location analysis, a flow trend analysis, a brand ranking analysis and a brand visitor overlapping analysis.

### FIELD OF THE INVENTION

The present invention relates to analysis equipment, and more particularly relates to an industrial trend analysis system.

### BACKGROUND OF THE INVENTION

For success of industrial development, managers should not only pay attention to application of funds and the labor supply, but should also focus more on dynamic marketing trends merchandise. In more detail, the managers should track and predict the real-time transaction status variation of target audience such as merchants, consumers and sales channels to correspondingly adjust a deployment of business strategy such as marketing or advertising to maximize business profits.

In other words, if a data analysis regarding transaction status of the target audience can be carefully performed to immediately and objectively determine the transaction status, it will be of great help to industrial development trends and a strategy adjustment.

### SUMMARY OF THE INVENTION

Therefore, one objective of the present invention is to provide an industrial trend analysis system which can analyze a market size, a consumer group profile, geographic location points, a flow trend and a brand ranking for a specific industry to control a commercial development of the specific industry.

In order to achieve the above objective, the present invention provides an industrial trend analysis system, comprising: a user data processing module which receives a plurality of individual data to obtain to-be-analyzed user cluster data, each individual data being corresponding to an individual visitor, and each individual data including website visiting history data, geographic location visiting history data and profile data, wherein the website visiting history data are visiting history of websites to which the individual visitor has visited, the geographic location visiting history data are visiting history of geographic location points to which the individual visitor has visited, the profile data are gender, age and/or interests of the individual visitor, the user data processing module is provided to sort, from the to-be-analyzed user cluster data, website visiting cluster data relating to a specific industry and geographic location points visiting cluster data relating to the specific industry, the website visiting cluster data are a cluster of the individual data whose website visiting history data includes the visiting history on any website relating to the specific industry, the geographic location points visiting cluster data are a cluster of the individual data whose geographic location visiting history data includes the visiting history on any geographic location point relating to the specific industry; and a group behavior analysis computing module being connected to the user data processing module to perform an industry insight analysis including a market size analysis, a potential consumer group profile analysis, a consumer geographic location analysis, a flow trend analysis, a brand ranking analysis and a brand visitor overlapping analysis, wherein the market size analysis is performed to compute the quantity of the individual visitors of the website visiting cluster data relating to the specific industry and/or the quantity of the individual visitors of the geographic location points visiting cluster data relating to the specific industry, the potential consumer group profile analysis is performed to obtain corresponding distribution states of the individual visitors of the website visiting cluster data relating to the specific industry and/or the geographic location points visiting cluster data relating to the specific industry in terms of gender, age, interest and/or browsing preferences, wherein the corresponding distribution states of the individual visitors in terms of gender, age and interest are derived from the profile data of the individual data corresponding to the individual visitors, and the corresponding distribution state of the individual visitors in terms of browsing preferences is derived from the website visiting history data and/or the geographic location visiting history data of the individual data corresponding to the individual visitors, the consumer geographic location analysis is performed to obtain the geographic location points where the individual visitor of the geographic location points visiting cluster data has stayed or visited to so as to derive the individual visitor's working place or residence, the flow trend analysis is performed to compute a variation of the quantity of the individual visitors of the website visiting cluster data relating to the specific industry over an analysis period and/or a variation of the quantity of the individual visitors of the geographic location points visiting cluster data relating to the specific industry over the analysis period, the brand ranking analysis is performed to compute a specific brand website visitor proportion and/or a specific brand geographic location point visitor proportion, wherein the specific brand website visitor proportion is the proportion of the quantity of the individual visitors of any website relating to a specific brand to the total quantity of the individual visitors in the website visiting cluster data, and the specific brand geographic location point visitor proportion is the proportion of the quantity of the individual visitors of any geographic location point relating to the specific brand to the total quantity of the individual visitors in the geographic location points visiting cluster data, the brand visitor overlapping analysis is performed to obtain the quantity of the individual visitors who have visited the websites relating to different the specific brands.

In one embodiment of the present invention, an industrial trend analysis system is provided, wherein each individual data further includes an individual identification code, which serves as an identifier of the individual data corresponding to the individual visitor for data processing in the user data processing module.

In one embodiment of the present invention, an industrial trend analysis system is provided, wherein the user data processing module is connected to an external database to receive the plurality of individual data from the external database, wherein the individual identification code of the individual data is obtained by performing a de-identification process on real identity features of the individual visitor in the external database.

In one embodiment of the present invention, an industrial trend analysis system is provided, wherein the user data processing module has a website visiting data pre-processing unit, the website visiting data pre-processing unit is provided to derive the website visiting history data of the individual data from the to-be-analyzed user cluster data according to a domain name format.

In one embodiment of the present invention, an industrial trend analysis system is provided, wherein the user data processing module has an offline visiting data pre-processing unit, the offline visiting data pre-processing unit is provided to derive the geographic location visiting history data of the individual data from the to-be-analyzed user cluster data according to a predetermined address data format, the predetermined address data format includes Arabic numerals, commas and decimal point.

In one embodiment of the present invention, an industrial trend analysis system is provided, wherein the geographic location visiting history data of the individual data includes longitude and latitude data of the geographic location point where the individual visitor has visited.

In one embodiment of the present invention, an industrial trend analysis system is provided, wherein the group behavior analysis computing module further has a period setting unit, the period setting unit is provided to set the analysis period so that the group behavior analysis computing module performs the market size analysis, the potential consumer group profile analysis, the consumer geographic location analysis, the flow trend analysis, the brand ranking analysis and the brand visitor overlapping analysis according to the analysis period.

The industrial trend analysis system of the present invention has the technical effects as follows. The market size, the consumer group profile, the geographic location points, the flow trend and the brand ranking relating to a specific industry can be obtained such that the business development trends of the specific industry can be analyzed.

### BRIEF DESCRIPTION OF THE DRAWINGS

FIG. 1 is a schematic block diagram illustrating an industrial trend analysis system according to one embodiment of the present invention;

FIG. 2 is a schematic diagram illustrating to-be-analyzed user cluster data of the industrial trend analysis system according to the embodiment of the present invention;

FIG. 3 is a schematic diagram illustrating a process of obtaining website visiting cluster data and geographic location points visiting cluster data by a user data processing module of the industrial trend analysis system according to the embodiment of the present invention;

FIG. 4 is a schematic diagram illustrating a flow trend analysis performed by a group behavior analysis computing module of the industrial trend analysis system according to the embodiment of the present invention; and

FIG. 5 is a schematic diagram illustrating a brand ranking analysis performed by the group behavior analysis computing module of the industrial trend analysis system according to the embodiment of the present invention.

### DETAILED DESCRIPTION OF THE PREFERRED EMBODIMENTS

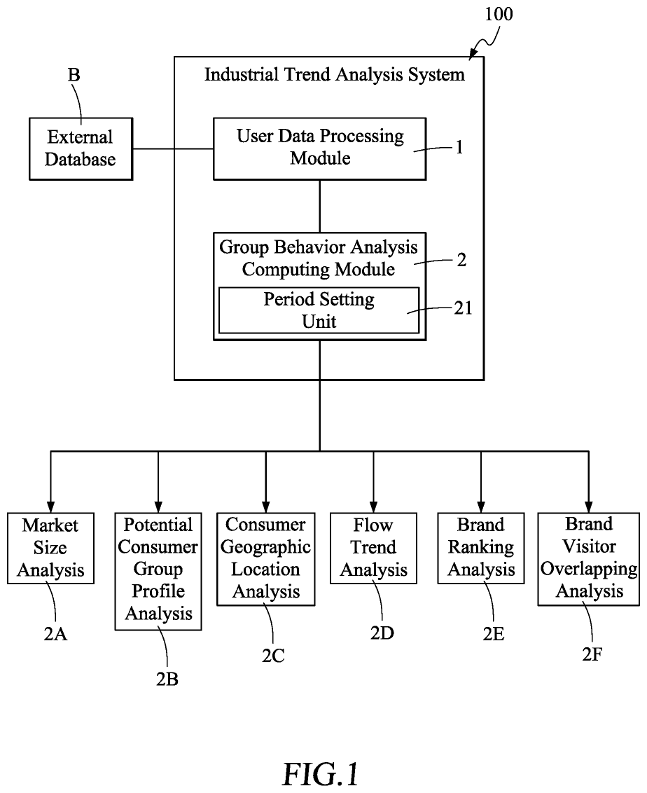

The preferred embodiments of the present invention are described in detail with reference to FIGS. 1 to 5. The description is used for explaining the embodiments of the present invention only, but not for limiting the scope of the claims.

As shown in FIG. 1, an industrial trend analysis system 100 according to one embodiment of the present invention comprises a user data processing module 1 and a group behavior analysis computing module 2. The industrial trend analysis system 100 of the present invention can analyze, for a specific industry, a market size, a potential consumer group profile (e.g., gender, age, interests and/or browsing preferences of consumers), geographic location points (e.g., individual visitors' working places or residences), a flow trend (i.e., a variation of the quantity of the individual visitors), a brand ranking (e.g., rankings of consumers' visits to websites or the geographic location points relating to specific brands) and a brand visitor overlap (i.e., an overlap among customers of websites or stores relating to brand A, brand B and brand C) so as to analyze a business development trend of the specific industry.

As shown in FIGS. 1 to 3, the user data processing module 1 receives a plurality of individual data 10 to obtain to-be-analyzed user cluster data 10G. Each of the individual data 10 is corresponding to an individual visitor, and each of the individual data 10 contains website visiting history data 10A, geographic location visiting history data 10B and profile data 10C.

Specifically, the website visiting history data 10A are visiting history of websites which the individual visitor has visited. The geographic location visiting history data 10B are visiting history of geographic location points which the individual visitor has visited. The profile data are gender, age and/or interests of the individual visitor.

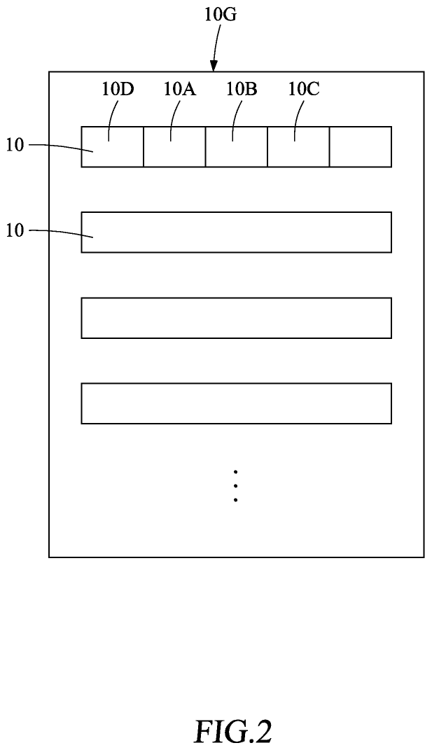

Furthermore, as shown in FIG. 2, according to the industrial trend analysis system 100 of one embodiment of the present invention, each of the individual data 10 further contains an individual identification code 10, which serves as an identifier of the individual data 10D corresponding to the individual visitor for data processing in the user data processing module 1.

In details, as shown in FIG. 1, according to the industrial trend analysis system 100 of one embodiment of the present invention, the user data processing module 1 is connected to an external database B to receive the plurality of individual data from the external database B. The individual identification code 10D of the individual data 10 is obtained by performing a de-identification process on real identity features of the individual visitor in the external database B. In the other words, the present invention performs the data processing and the analysis on the to-be-analyzed user cluster data 10G without revealing the real identity features of the individual visitor, in compliance with the Personal Data Protection Act. The external database B can be obtained from a telecommunications data provider but is not limited thereto.

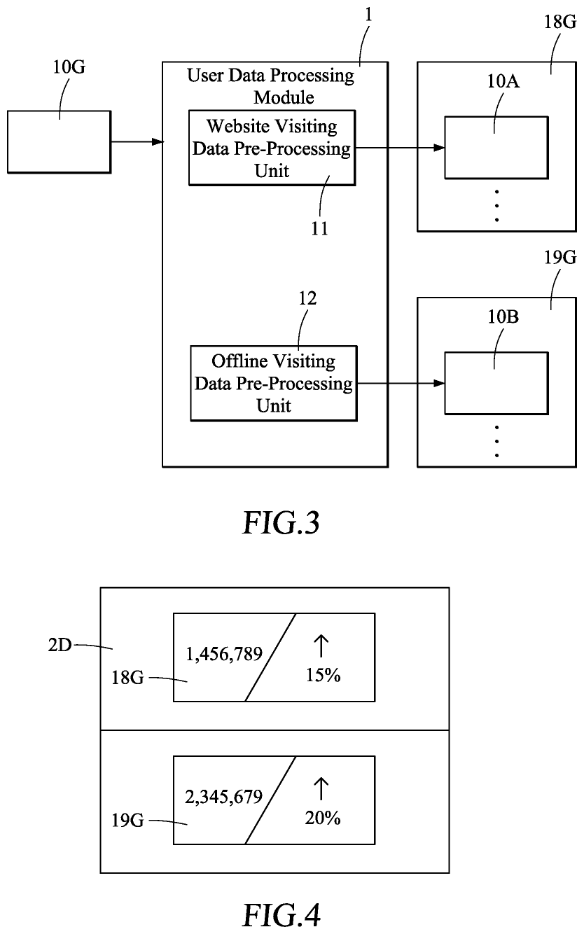

For example, as shown in FIGS. 1 and 3, the user data processing module 1 is provided to sort, from the to-be-analyzed user cluster data 10G, website visiting cluster data 18G relating to a specific industry and geographic location points visiting cluster data 19G relating to the specific industry. The website visiting cluster data 18G are a cluster of the individual data 10 whose website visiting history data 10A include the visiting history on any website relating to the specific industry. The geographic location points visiting cluster data 19G are a cluster of the individual data 10 whose geographic location visiting history data 10B include the visiting history on any geographic location point relating to the specific industry.

In a specific embodiment of the present invention, as shown in FIG. 3, according to the industrial trend analysis system 100 of one embodiment of the present invention, the user data processing module 1 has a website visiting data pre-processing unit 11. The website visiting data pre-processing unit 11 is provided to derive the website visiting history data 10A of the individual data 10 from the to-be-analyzed user cluster data 10G according to a domain name format.

In addition, as shown in FIG. 3, according to the industrial trend analysis system 100 of one embodiment of the present invention, the user data processing module 1 has an offline visiting data pre-processing unit 12. The offline visiting data pre-processing unit 12 is provided to derive the geographic location visiting history data 10B of the individual data 10 from the to-be-analyzed user cluster data according to a predetermined address data format, wherein the predetermined address data format includes Arabic numerals, commas and decimal point.

Furthermore, according to the industrial trend analysis system 100 of one embodiment of the present invention, the geographic location visiting history data 10B of the individual data 10 include longitude and latitude data of the geographic location point where the individual visitor has visited.

As shown in FIG. 1, the group behavior analysis computing module 2 is connected to the user data processing module 1 to perform an industry insight analysis including a market size analysis 2A, a potential consumer group profile analysis 2B, a consumer geographic location analysis 2C, a flow trend analysis 2D, a brand ranking analysis 2E and a brand visitor overlapping analysis 2F. In other words, the group behavior analysis computing module 2 obtains basic data of the website visiting cluster data 18G and basic data of the geographic location points visiting cluster data 19G through the user data processing module 1, and the group behavior analysis computing module 2 derives analysis results including a market size, a consumer group profile, a geographic location point, a flow trend, a brand ranking and a brand visitor overlap by computing the basic data.

In detail, as shown in FIG. 1, according to the industrial trend analysis system 100 of one embodiment of the present invention, the group behavior analysis computing module 2 further has a period setting unit 21. The period setting unit 21 is provided to set an analysis period. Therefore, the group behavior analysis computing module 2 performs the market size analysis 2A, the potential consumer group profile analysis 2B, the consumer geographic location analysis 2C, the flow trend analysis 2D, the brand ranking analysis 2E and the brand visitor overlapping analysis 2F according to the analysis period. For example, after the analysis period was set by the period setting unit 21, the group behavior analysis computing module 2 can further perform a daily routine sort on the website visiting cluster data 18G and the geographic location points visiting cluster data 19G which are transmitted from the user data processing module 1 for subsequent individual behavior data analysis.

In detail, the market size analysis 2A is performed to compute the quantity of the individual visitors of the website visiting cluster data 18G relating to the specific industry and/or the quantity of the individual visitors of the geographic location points visiting cluster data 19G relating to the specific industry. In other words, the present invention determines the market size of the specific industry based on the quantity of the individual visitors who have visited the websites of the specific industry and/or the quantity of the individual visitors who have visited the geographic location points of the specific industry.

The potential consumer group profile analysis 2B is performed to obtain corresponding distribution states of the individual visitors of the website visiting cluster data 18G relating to the specific industry and/or the geographic location points visiting cluster data 19G relating to the specific industry in terms of gender, age, interests and/or browsing preferences. Moreover, the corresponding distribution states of the individual visitors in terms of gender, age and interests are derived from the profile data 10C of the individual data 10 corresponding to the individual visitors. The corresponding distribution state of the individual visitors in terms of browsing preferences is derived from the website visiting history data 10A and/or the geographic location visiting history data 10B of the individual data 10 corresponding to the individual visitors.

In the present invention, the potential consumer group profile analysis 2B is to explore the distribution states of the individual visitors who have visited the websites and/or the geographic location points of the specific industry in terms of gender, age and interests and/or browsing preferences. Therefore, the profile characteristics of the individual visitors who have active consumer intentions for the specific industry can be identified, and can be used as a proposed constraint for targeting the target audience of the advertisement so as to facilitate the promotion of subsequent strategies of marketing and advertising.

The consumer geographic location analysis 2C is performed to obtain the geographic location points where the individual visitor of the geographic location points visiting cluster data 19G has stayed or visited to so as to derive the individual visitor's location, such as working place or residence.

The flow trend analysis 2D is performed to compute a variation of the quantity of the individual visitors of the website visiting cluster data 18G relating to the specific industry over the analysis period and/or a variation of the quantity of the individual visitors of the geographic location points visiting cluster data 19G relating to the specific industry over the analysis period.

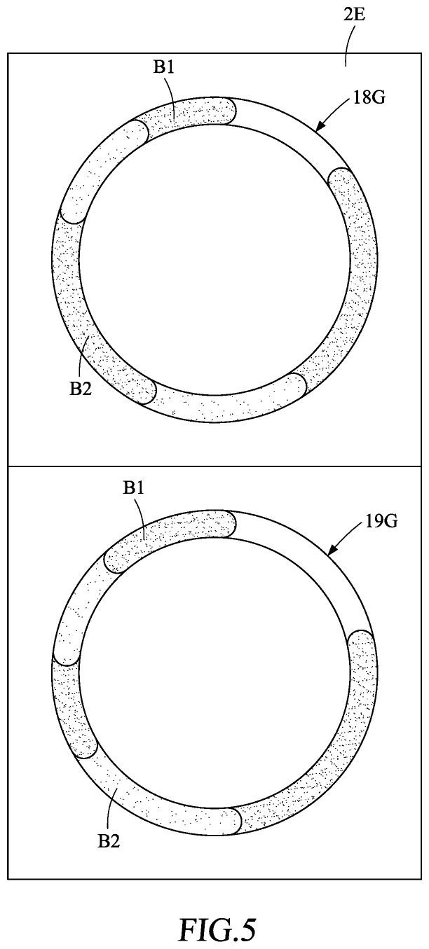

The analysis results of the flow trend analysis 2D may be expressed as follows. As shown in FIG. 4, the variation of the quantity of the individual visitors of the website visiting cluster data 18G relating to the specific industry (e.g., automotive sales industry) is increased by 15% over the analysis period (e.g., compared to the previous month). The variation of the quantity of the individual visitors of the geographic location point visiting cluster data 19G relating to the specific industry (e.g., automotive sales industry) is increased by 20% over the analysis period (e.g., compared to the previous month).

The brand ranking analysis 2E is performed to compute a specific brand website visitor proportion and/or a specific brand geographic location point visitor proportion. The specific brand website visitor proportion is the proportion of the quantity of the individual visitors of any website relating to a specific brand to the total quantity of the individual visitors in the website visiting cluster data 18G. The specific brand geographic location point visitor proportion is the proportion of the quantity of the individual visitors of any geographic location point relating to the specific brand to the total quantity of the individual visitors in the geographic location points visiting cluster data 19G.

The analysis results of the brand ranking analysis 2E may be expressed as follows. As shown in FIG. 5, the specific brand website visitor proportion for a specific brand B1 may be expressed as a proportion of the quantity of the individual visitors of the websites relating to the specific brand B1 to the total quantity of the individual visitors in the website visiting cluster data 18G. The specific brand website visitor proportion for a specific brand B2 may be expressed as a proportion of the quantity of the individual visitors of the websites relating to the specific brand B2 to the total quantity of the individual visitors in the website visiting cluster data 18G. In addition, as shown in FIG. 5, the specific brand geographic location point visitor proportion for the specific brand B1 may be expressed as a proportion of the quantity of the individual visitors of the geographic location points relating to the specific brand B1 to the total quantity of the individual visitors in the geographic location points visiting cluster data 19G. The specific brand geographic location point visitor proportion for the specific brand B2 may be expressed as a proportion of the quantity of the individual visitors of the geographic location points relating to the specific brand B2 to the total quantity of the individual visitors in the geographic location points visiting cluster data 19G.

The brand visitor overlapping analysis 2F is performed to obtain the quantity of the individual visitors who have visited the websites relating to different the specific brands. For example, the present invention can find out whether the visitors who have visited the website of the brand A have also visited the websites of the brand B and the brand C by the brand visitor overlapping analysis 2F so as to determine a competitive relationship among different brands for the same kind of merchandise.

As mentioned above, the industrial trend analysis system 100 of the present invention analyzes and computes the website visiting cluster data 18G and the geographic location points visiting cluster data 19G with the user data processing module 1 and the group behavior analysis computing module 2 so as to obtain the business development trends such as the market size, the consumer group profile, the geographic location points, the flow trend and the brand ranking of the specific industry. Therefore, the industrial trend analysis system 100 of the present invention can provide a reference for analyzing the development trend relating to the specific industry so as to facilitate a future development plan of the specific industry.

The above description should be considered as only the discussion of the preferred embodiments of the present invention. However, a person having ordinary skill in the art may make various modifications without deviating from the present invention. Those modifications still fall within the scope of the present invention.

What is claimed is:

1. An industrial trend analysis system, comprising:
a user data processing module which receives a plurality of individual data to obtain to-be-analyzed user cluster data, each individual data being corresponding to an individual visitor, and each individual data including website visiting history data, geographic location visiting history data and profile data, wherein the website visiting history data are visiting history of websites to which the individual visitor has visited, the geographic location visiting history data are visiting history of geographic location points to which the individual visitor has visited, the profile data are gender, age and/or interests of the individual visitor, the user data processing module is provided to sort, from the to-be-analyzed user cluster data, website visiting cluster data relating to a specific industry and geographic location points visiting cluster data relating to the specific industry, the website visiting cluster data are a cluster of the individual data whose website visiting history data includes the visiting history on any website relating to the specific industry, the geographic location points visiting cluster data are a cluster of the individual data whose geographic location visiting history data includes the visiting history on any geographic location point relating to the specific industry; and
a group behavior analysis computing module being connected to the user data processing module to perform an industry insight analysis including a market size analysis, a potential consumer group profile analysis, a consumer geographic location analysis, a flow trend analysis, a brand ranking analysis and a brand visitor overlapping analysis,
wherein
the market size analysis is performed to compute the quantity of the individual visitors of the website visiting cluster data relating to the specific industry and/or the quantity of the individual visitors of the geographic location points visiting cluster data relating to the specific industry,
the potential consumer group profile analysis is performed to obtain corresponding distribution states of the individual visitors of the website visiting cluster data relating to the specific industry and/or the geographic location points visiting cluster data relating to the specific industry in terms of gender, age, interests and/or browsing preferences, wherein the corresponding distribution states of the individual visitors in terms of gender, age and interests are derived from the profile data of the individual data corresponding to the individual visitors, and the corresponding distribution state of the individual visitors in terms of browsing preferences is derived from the website visiting history data and/or the geographic location visiting history data of the individual data corresponding to the individual visitors,
the consumer geographic location analysis is performed to obtain the geographic location points where the individual visitor of the geographic location points visiting cluster data has stayed or visited to so as to derive the individual visitor's working place or residence,
the flow trend analysis is performed to compute a variation of the quantity of the individual visitors of the website visiting cluster data relating to the specific industry over an analysis period and/or a variation of the quantity of the individual visitors of the geographic location points visiting cluster data relating to the specific industry over the analysis period,
the brand ranking analysis is performed to compute a specific brand website visitor proportion and/or a specific brand geographic location point visitor proportion, wherein the specific brand website visitor proportion is the proportion of the quantity of the individual visitors of any website relating to a specific brand to the total quantity of the individual visitors in the website visiting cluster data, and the specific brand geographic location point visitor proportion is the proportion of the quantity of the individual visitors of any geographic location point relating to the specific brand to the total quantity of the individual visitors in the geographic location points visiting cluster data,
the brand visitor overlapping analysis is performed to obtain the quantity of the individual visitors who have visited the websites relating to different the specific brands.

2. The industrial trend analysis system as claimed in claim 1, wherein each individual data further includes an individual identification code, which serves as an identifier of the individual data corresponding to the individual visitor for data processing in the user data processing module.

3. The industrial trend analysis system as claimed in claim 2, wherein the user data processing module is connected to an external database to receive the plurality of individual data from the external database, wherein the individual identification code of the individual data is obtained by performing a de-identification process on real identity features of the individual visitor in the external database.

4. The industrial trend analysis system as claimed in claim 1, wherein the user data processing module has a website visiting data pre-processing unit, the website visiting data pre-processing unit is provided to derive the website visiting history data of the individual data from the to-be-analyzed user cluster data according to a domain name format.

5. The industrial trend analysis system as claimed in claim 1, wherein the user data processing module has an offline visiting data pre-processing unit, the offline visiting data pre-processing unit is provided to derive the geographic location visiting history data of the individual data from the to-be-analyzed user cluster data according to a predetermined address data format, the predetermined address data format includes Arabic numerals, commas and decimal point.

6. The industrial trend analysis system as claimed in claim 1, wherein the geographic location visiting history data of the individual data includes longitude and latitude data of the geographic location point where the individual visitor has visited.

7. The industrial trend analysis system as claimed in claim 1, wherein the group behavior analysis computing module further has a period setting unit, the period setting unit is provided to set the analysis period so that the group behavior analysis computing module performs the market size analysis, the potential consumer group profile analysis, the consumer geographic location analysis, the flow trend analysis, the brand ranking analysis and the brand visitor overlapping analysis according to the analysis period.
